(19) United States
(12) Patent Application Publication
(10) Pub. No.: US 2006/0266104 A1
(43) Pub. Date: Nov. 30, 2006

(54) System for detecting moisture in a garment

(76) Inventor: Thomas Alan Gordon, Round Rock, TX (US)

Correspondence Address: Thomas A. Gordon, 4001 Stoney Hill, Round Rock, TX, 78681, US

(21) Appl. No.: 11/140,301

(22) Filed: May 31, 2005

(51) Int. Cl. G01N 5/02

(52) U.S. Cl. 73/73

(57) ABSTRACT

A system is disclosed for detecting moisture in a garment. The system comprises at least one moisture detection portion integrated with the garment. Each moisture detection portion comprises a cathode and an anode and may also comprise a housing or panel surrounding the electrodes. The system also comprises at least one switching mechanism for receiving a positive voltage from the cathode and the anode of a moisture detection portion, when the cathode and the anode are in the presence of a polar liquid. Each switching mechanism comprises at least one switching component and at least one power source. Each switching mechanism supplies current from at least one of its power sources to at least one notification device or at least one transmitter, or both, when its switching components are activated.

### BACKGROUND OF THE INVENTION

1. Field of the Invention

The invention is directed generally toward systems for detecting the presence of fluids. More specifically, the invention is directed toward systems for detecting and signaling the presence of moisture in a garment.

2. Description of Related Art

Protective undergarments are used to accommodate individuals who have difficulties controlling their discharge of bodily waste. The most common example of such undergarments are diapers worn by children who have not been toilet-trained. Age and medical conditions also make undergarments necessary for many adults. The undergarments protect external clothing and prevent embarrassing leaks or smells that result from incontinence. Nonetheless, undergarments have limited capacities for fluids and other waste and must be periodically changed to provide their benefits and to prevent health risks to skin. Quick detection of fluids allows a person to change undergarments regularly.

Various devices exist that are designed to detect the presence of fluids on surfaces. However, these devices are constructed to detect leaks in pipes, boats, water heaters and tanks, and other constructs. These devices have not been integrated with a garment to signal the conditions described above. The integration of a moisture detection and signaling device, such as one similar to that disclosed in U.S. application Ser. No. 10/844,001, with a garment would provide a range of benefits. For instance, it can signal parents when a child needs changing, before the child's skin becomes infected or odors affect surrounding people. It can also signal health care workers when bed-ridden patients need new garments. It can also help to train children to use restroom facilities and to stop bed-wetting problems. Hence, there is a great need for a detection system that reliably detects small amounts of moisture in a garment and signals such conditions, without posing any additional health risks to wearers of the garments.

### SUMMARY OF THE INVENTION

The current invention provides a system for detecting moisture in a garment. The system reliably detects small moisture in a garment and signals such conditions, without posing any additional health risks to wearers of the garments. The system comprises at least one moisture detection portion integrated with the garment. Each moisture detection portion comprises a cathode and an anode. Each moisture detection portion may also comprise a housing or panel, such as a portion of plastic or other material that surrounds the electrodes. The system also comprises at least one switching mechanism for receiving a positive voltage from the cathode and the anode of a moisture detection portion, when the electrodes are in the presence of a polar liquid. Each switching mechanism comprises at least one switching component and at least one power source. Each switching mechanism supplies current from at least one of its power sources to at least one notification device and/or at least one transmitter, when its switching components are activated.

Each switching component may comprise a switching transistor, a voltage comparator, an operational amplifier, a thyristor, or a field-effect transistor. Preferably, each switching component is activated, when the switching component receives a voltage that exceeds a threshold voltage. The threshold voltage may be zero volts or greater than zero volts, depending upon the type of switching component used. The sensitivity of each switching mechanism may be adjustable. Notification devices may comprise one or more devices, such as an alarm with volume control, a piezoelectric buzzer with volume control, an audio speaker with volume control, a light, a light-emitting diode, or a vibrating portion. Each transmitter communicates with remote notification devices via at least one signal, such as radio waves, infrared radiation, rolling code signals, billion code signals, 9-pin DIP code signals, and 12-pin DIP code signals.

The anode and the cathode of each moisture detection portion may be electrically connected with a snap unit, which fastens a housing containing the at least one switching mechanism to the garment. The snap unit, in such an embodiment, comprises a dual electrode and is electrically connected with the at least one switching mechanism. Alternatively, the anode may be electrically connected with a first snap unit, and the cathode may be electrically connected with a second snap unit. The first and second snap units, in such an embodiment, are each electrically connected with the at least one switching mechanism.

### BRIEF DESCRIPTION OF THE DRAWINGS

FIG. 1 is a block diagram illustrating component devices that comprise one embodiment of the current invention.

FIG. 2 is a block diagram illustrating component devices that comprise a second embodiment of the current invention.

FIG. 3 is a block diagram illustrating component devices that comprise a third embodiment of the current invention.

FIG. 4 is a pictorial diagram illustrating a perspective view of a top or bottom surface of the moisture detection portion shown in FIGS. 1-3.

FIG. 5 is a circuit diagram illustrating one embodiment of the switching mechanism shown in FIGS. 1-3.

FIG. 6 is a circuit diagram illustrating a second embodiment of the switching mechanism shown in FIGS. 1-3.

FIG. 7 is a circuit diagram illustrating a third embodiment of the switching mechanism shown in FIGS. 1-3.

FIG. 8 is a circuit diagram illustrating the preferred embodiment of the switching mechanism shown in FIGS. 1-3.

FIG. 9A is a pictorial diagram illustrating a top view of one embodiment of the invented system, integrated with a garment.

FIG. 9B is a pictorial diagram illustrating a front view of one embodiment of the invented system, integrated with a garment.

FIG. 10 is a pictorial diagram illustrating a front view of a second embodiment of the invented system, integrated with a garment.

FIG. 11 is a pictorial diagram illustrating components of the snap portion illustrated in FIGS. 9A and 9B.

FIG. 12A is a pictorial diagram illustrating a front view of one embodiment of a housing containing at least one switching mechanism, removably attached with a garment.

FIG. 12B is a pictorial diagram illustrating a side view of one embodiment of a housing containing at least one switching mechanism, removably attached with a garment.

FIG. 13 is a pictorial diagram illustrating a front view of a second embodiment of a housing containing at least one switching mechanism, removably attached with a garment.

### DETAILED DESCRIPTION

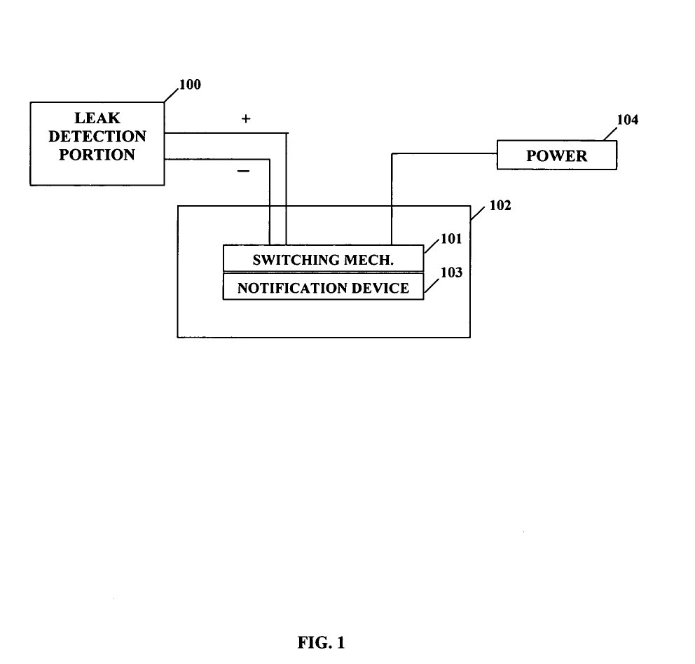

FIG. 1 illustrates component devices of one embodiment of the current invention. The system comprises at least one moisture detection portion 100 that is integrated with a garment. Each moisture detection portion 100 comprises a cathode and anode, which form a galvanic cell when in contact with a polar liquid. The cathode and anode of each moisture detection portion 100 are electrically connected with a switching mechanism 101. Each switching mechanism 101 comprises at least one transistor, silicon-controlled rectifier (thyristor), operational amplifier, voltage comparator, field effect transistor (FET), or other switching component that allows usable current from a power source 104 to flow through the component and drive other circuitry, when its threshold voltage is met or exceeded by the voltage produced by moisture detection portion 100 in the presence of moisture. The threshold voltage of each switching component may be zero volts (0V) or a positive voltage. Preferably, each switching mechanism 101 comprises at least one transistor or voltage comparator. In the preferred embodiment of the invention, at least one transistor is used. The sensitivity of each switching mechanism 101 may be selectable by a user.

In the embodiment shown in FIG. 1, each switching mechanism 101 and notification device 103 may be enclosed in a single housing 102 that is also integrated with the garment. Each switching mechanism 101 is connected with at least one power source 104, which may comprise a battery. Each notification device 103 may comprise one or more components that are activated by current flowing from power source 104, such as an alarm with volume control, a piezoelectric buzzer with volume control, an audio speaker with volume control, an indicator light or LED, a vibrating component or silent mode, or other component suitable for notifying garment wearers of the presence of moisture. When the cathode and anode of a moisture detection portion 100 produce a voltage that meets or exceeds the threshold voltage of the component(s) of a connected switching mechanism 101, current from power source 104 drives the connected notification device 103.

Each moisture detection portion 100 may be integrated with the garment through unitary construction with the garment, by being sewn into the garment, or by removable attachment with the garment. Housing 102 may be integrated with the garment through unitary construction with the garment, by being sewn into the garment, or by removable attachment with the garment.

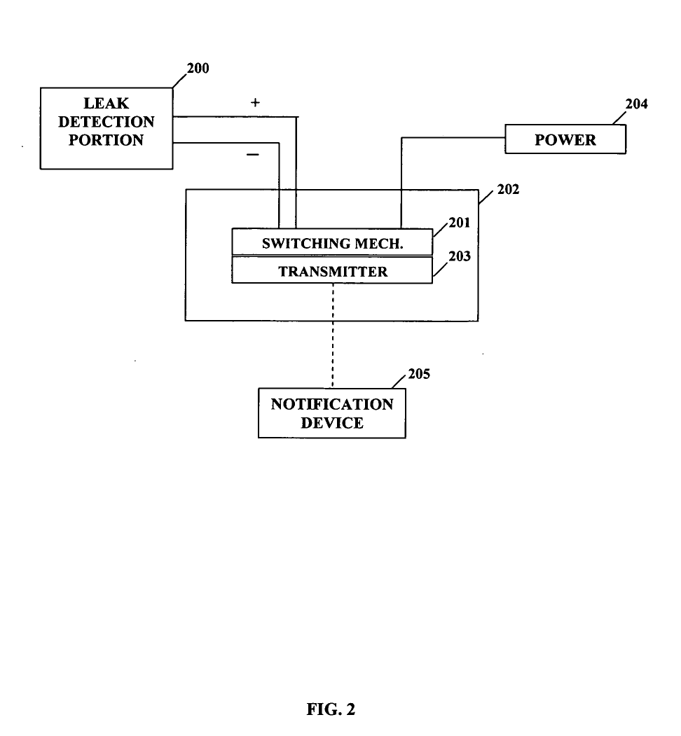

FIG. 2 illustrates component devices of a second embodiment of the current invention. In the embodiment shown in FIG. 2, the system comprises at least one moisture detection portion 200 that is integrated with a garment. Each moisture detection portion 200 comprises a cathode and anode, which form a galvanic cell when in contact with a polar liquid. The cathode and anode of each moisture detection portion 200 are electrically connected with a switching mechanism 201. Each switching mechanism 201 comprises at least one of the switching components described with reference to FIG. 1, which allows usable current from a power source 204 to flow through the component and drive other circuitry, when its threshold voltage is met or exceeded by the voltage produced by moisture detection portion 200 in the presence of moisture. The threshold voltage of each switching component may be zero volts (0V) or a positive voltage. Preferably, each switching mechanism 201 comprises at least one transistor or voltage comparator. In the preferred embodiment of the invention, at least one transistor is used. The sensitivity of each switching mechanism 201 may be selectable by a user.

Unlike the embodiment shown in FIG. 1, each switching mechanism 201 communicates with at least one remote notification device 205, via at least one transmitter 203. Each switching mechanism and transmitter 203 may be enclosed in a single housing 202 that is integrated with the same garment as moisture detection portion 200. Each switching mechanism 201 is connected with at least one power source 204, which may comprise a battery. When the cathode and anode of a moisture detection portion 200 produce a voltage that meets or exceeds the threshold voltage of the component(s) of a connected switching mechanism 201, current from at least one power source 204 drives the connected transmitter 203. The transmitter 203 communicates a signal to at least one remote notification device 205, via radio waves, infrared radiation, or other signal means known to those skilled in the art. Preferably, each transmitter 203 uses a signal type that will not interfere with other systems, such as electronics or telephone equipment. In the preferred embodiment of the invention, each transmitter 203 uses coded signals, such as ‘rolling code,’ ‘billion code,’ or 9 or 12-pin DIP switch code systems.

The communication of a signal from a transmitter 203 to a remote notification device 205 indicates that moisture detection portion 200 has detected moisture in the garment. Each remote notification device 205 may comprise one or more components, such as an alarm with volume control, a piezoelectric buzzer with volume control, an audio speaker with volume control, an indicator light or LED, a vibrating component or silent mode, or other component suitable for notifying remote parties or garment wearers of the presence of moisture and the need for the garment to be changed. A remote notification device 205 may also comprise a baby monitor. This embodiment is particularly useful for parents and health care or child care workers who may need to monitor patient or child systems from a remote location. Where a remote notification device 205 comprises an alarm, a piezoelectric buzzer, or audio speaker, transmitters in each garment preferably emit a unique tone or one of a discrete number of tones, such that individual wearers may be identified.

Between a switching mechanism 201 and a transmitter 203 may be other circuits, such as ‘one-shot circuits,’ that can be made to activate the transmitter 203 for a certain amount of time and ‘pulse generators’ that can pulse the transmitter 203, or a combination of the two that would then activate a transmitter 203 for a limited period or periods of time. This can ensure transmission of signals by a transmitter 203 without draining its connected power source 204 at a high rate.

Each moisture detection portion 200 may be integrated with the garment through unitary construction with the garment, by being sewn into the garment, or by removable attachment with the garment. Housing 202 may be integrated with the garment through unitary construction with the garment, by being sewn into the garment, or by removable attachment with the garment.

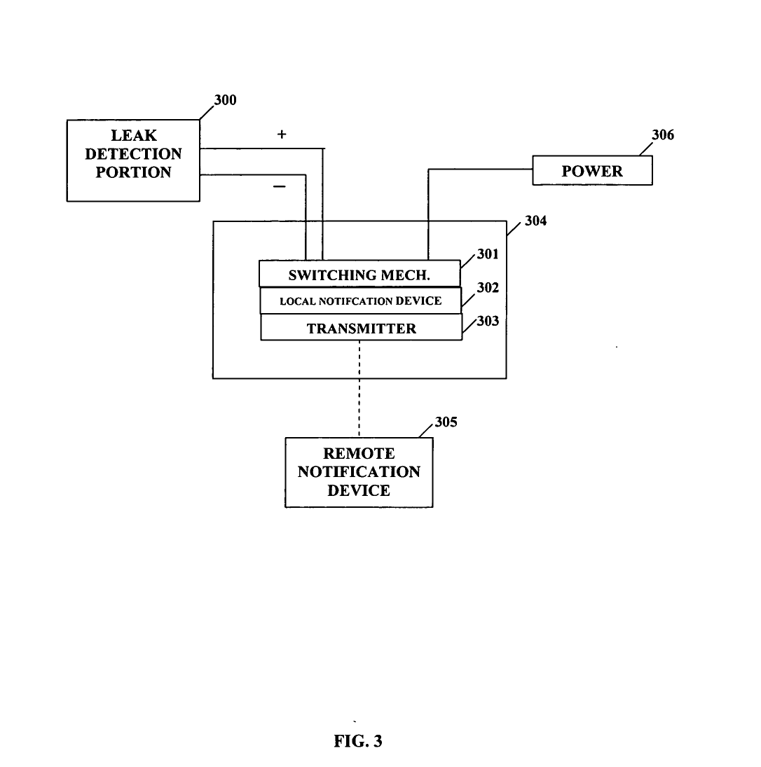

FIG. 3 illustrates component devices of a third embodiment of the current invention. In the embodiment shown in FIG. 3, the system comprises at least one moisture detection portion 300 that is integrated with a garment. Each moisture detection portion 300 comprises a cathode and anode, which form a galvanic cell when in contact with a polar liquid. The cathode and anode of each moisture detection portion 300 are electrically connected with a switching mechanism 301. Each switching mechanism 301 comprises at least one of the switching components described with reference to FIG. 1, which allows usable current from a power source 306 to flow through the component and drive other circuitry, when its threshold voltage is met or exceeded by the voltage produced by moisture detection portion 300 in the presence of moisture. The threshold voltage of each switching component may be zero volts (0V) or a positive voltage. Preferably, each switching mechanism 301 comprises at least one transistor or voltage comparator. In the preferred embodiment of the invention, at least one transistor is used. The sensitivity of each switching mechanism 301 may be selectable by a user.

In this embodiment, each switching mechanism 301 is electrically connected with at least one local notification device 302. Each switching mechanism is also electrically connected with at least one power source 306. Each switching mechanism 301 also communicates remotely with at least one remote notification device 305, via at least one transmitter 303. Whether a local notification device 302, a remote notification device 305, or both, are used to indicate the presence of moisture in the garment may be selectable, through ON/OFF switches or other means known to those skilled in the art. Each switching mechanism 301, local notification device 302, and transmitter unit 303, may be enclosed in a single housing 304 that is integrated with the same garment as moisture detection portion 300.

When the cathode and anode of a moisture detection portion 300 produce a voltage that meets or exceeds the threshold voltage of the component(s) of a switching mechanism 301, current from power source(s) 306 drives the connected local notification device 302 and/or transmitter 303. If the transmitter 303 is activated, it communicates a signal to at least one remote notification device 305, via radio waves, infrared radiation, or other signal means known to those skilled in the art. Preferably, each transmitter 303 uses a signal type that will not interfere with other systems, such as electronics or telephone equipment. In the preferred embodiment of the invention, each transmitter 303 uses coded signals, such as ‘rolling code,’ ‘billion code,’ or 9 or 12-pin DIP switch code systems.

Each local notification device 303 and remote notification device 303 may comprise one or more components, such as an alarm with volume control, a piezoelectric buzzer with volume control, an audio speaker with volume control, an indicator light or LED, a vibrating component or silent mode, or other component suitable for notifying remote parties or garment wearers of the presence of moisture and the need for the garment to be changed. A remote notification device 305 may also comprise a baby monitor. This embodiment is particularly useful for parents and health care or child care workers who may need to monitor patient or child systems from a remote location. Where a notification device 305 comprises an alarm, a piezoelectric buzzer, or audio speaker, transmitters in each garment preferably emit a unique tone or one of a discrete number of tones, such that individual wearers may be identified.

Between a switching mechanism 301 and a transmitter 303 may be other circuits, such as ‘one-shot circuits,’ that can be made to activate the transmitter 303 for a certain amount of time and ‘pulse generators’ that can pulse a transmitter 303, or a combination of the two that would then activate a transmitter 303 for a limited period or periods of time. This can ensure transmission of signals by a transmitter 303 without draining its connected power source 306 at a high rate.

Each moisture detection portion 300 may be integrated with the garment through unitary construction with the garment, by being sewn into the garment, or by removable attachment with the garment. Housing 304 may be integrated with the garment through unitary construction with the garment, by being sewn into the garment, or by removable attachment with the garment.

Though FIG. 3 seems to illustrate switching mechanism 301, local notification device 302, and transmitter 303 in series, those skilled in the art will recognize that these components may be placed in parallel, such that switching mechanism need not drive a local notification device 302 before driving transmitter 303, or vice versa.

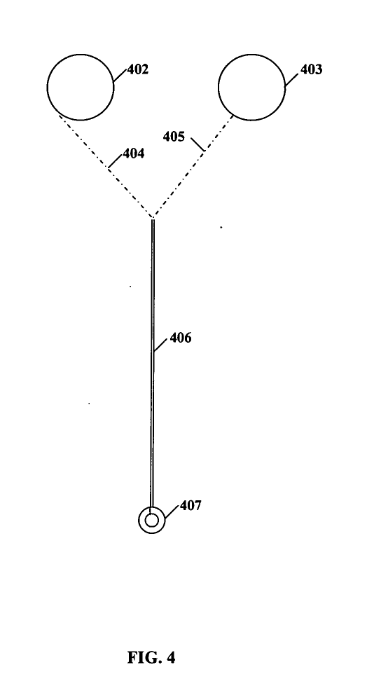

FIG. 4 illustrates a moisture detection portion, in accordance with the current invention. Each moisture detection portion comprises a cathode 402 and an anode 403 positioned such that they are not in contact with each other. The electrodes comprise two dissimilar metals that form a galvanic cell, when both electrodes are in contact with a polar liquid. Preferably, the electrodes also comprise substantially non-reactive, nontoxic material materials that are durable, corrode at slow rates, and do not form a stable film of oxidation. The combination of metals used for cathode 402 and anode 403 preferably gives rise to a cell potential that does not exceed 1 Volt in the presence of urine, such that no risk of shock is posed to the user. Cathode 402 may comprise platinum, gold, copper, stainless steel, or other suitable metals known to those skilled in the art. Cathode 402 preferably comprises copper. Anode 403 may comprise zinc, aluminum, or other suitable metal known to those skilled in the art. Anode 403 preferably comprises zinc.

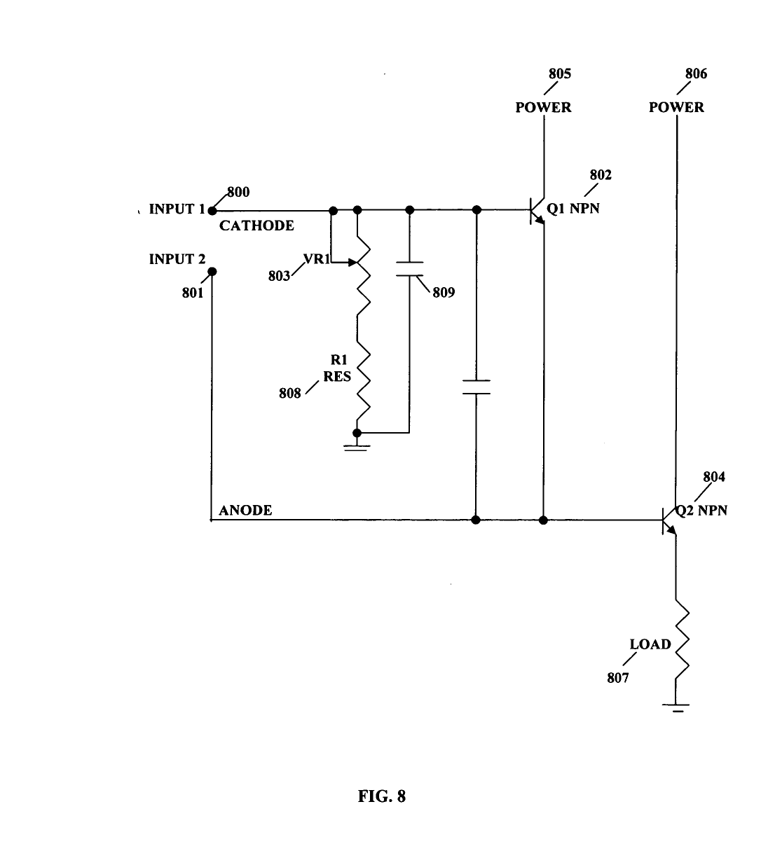

Each electrode is preferably the size of a penny, though they may be larger or smaller. One surface of each electrode is exposed inside the garment. The exposed surfaces of the electrodes may be covered by an absorbent or porous material that allows the electrodes to detect the presence of moisture in the garment, without direct contact between the electrodes and a wearer's skin. Those skilled in the art will appreciate that the positions of the two electrodes may be reversed or otherwise manipulated without departing from the scope of the invention. Each electrode may be integrated individually with the garment, in any manner described with reference to FIGS. 1-3. Alternatively, the moisture detection portion may also comprise a housing or panel that surrounds the electrodes as shown in FIGS. 8A and 8B. This housing or panel allows the electrodes to be integrated with a garment as one unit, in any manner described with reference to FIGS. 1-3, after production of the garment. The panel may be formed of rubber, plastic or other flexible, durable, non-absorbent, and electrically non-conductive material that may be integrated with a garment.

Wires 404 and 405 are connected with the electrodes and may extend through parallel lengths of insulation 406 to connect with a notification device or remote transmission unit, as described with reference to FIGS. 1 and 2. Wires 404 and 405 may connect directly to terminals of a switching mechanism, they may connect to a switching mechanism via an input jack, or they may connected to a switching mechanism via at least one snap unit 407, which connects with a switching mechanism, as further described herein. Wires 404 and 405 preferably extend through the garment material to prevent direct contact with the wearer.

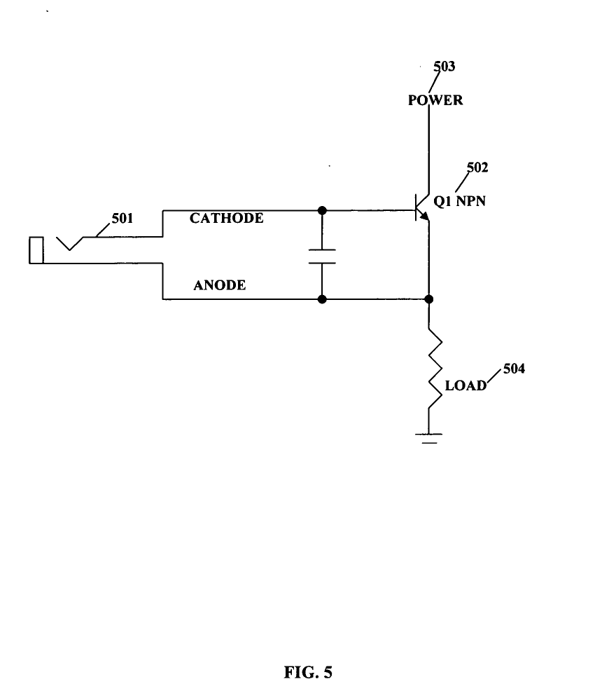

FIGS. 5-8 illustrate embodiments of a circuit that acts as the switching component of the switching mechanism described with reference to FIGS. 1 and 2. FIG. 5 illustrates a switching component employing a NPN transistor and an input jack. In this embodiment, the output jack shown at 307 in FIG. 3 is connected with an input jack 501, such that the cathode of a moisture detection portion is connected with the base of the NPN transistor (Q1) 502 and the anode of the moisture detection portion is connected with the emitter of the transistor 502. The collector of the transistor is connected with a source of electric current 503, such as a battery. When the threshold voltage of transistor 502 is met or exceeded by current from the cathode and anode of the moisture detection portion, current from current source 503 flows across the transistor to drive a load 504, such as one or more circuits of a transmitter or notification device.

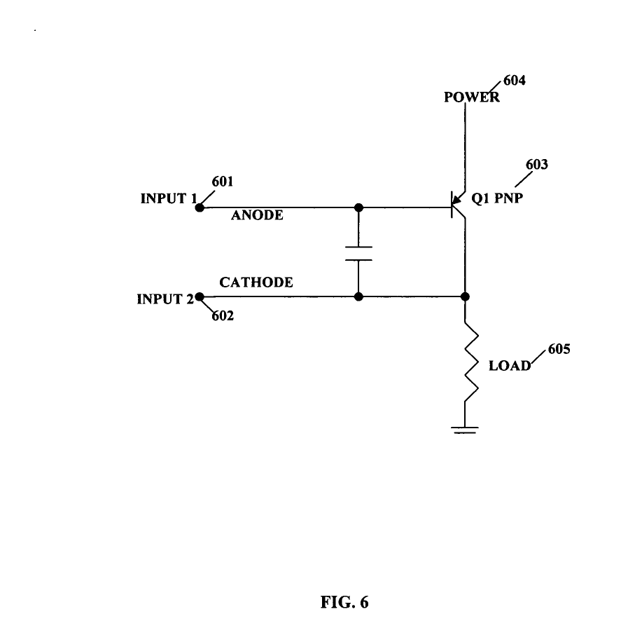

FIG. 6 illustrates a switching component employing a PNP transistor without an input jack. In this embodiment, the anode of a moisture detection portion is connected with the base of a PNP transistor 603 via a first input terminal 601 and the cathode of the moisture detection portion is connected with the collector of the transistor 603 via a second input terminal 602. The emitter of transistor 603 is connected with a source of electric current 604, such as a battery. When the threshold voltage of transistor 603 is met or exceeded by current from the cathode and anode of a moisture detection portion, current from current source 604 flows across transistor 603 to drive a load 605, such as one or more circuits of a transmitter or notification device.

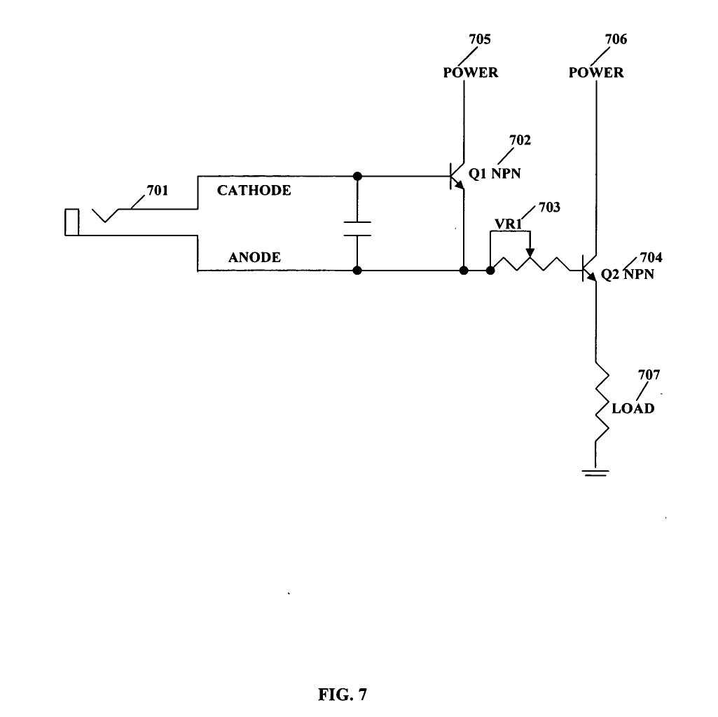

FIG. 7 is a circuit diagram illustrating a switching mechanism with variable sensitivity. This embodiment of a switching mechanism utilizes two cascaded NPN transistors and a potentiometer for allowing a user to select the sensitivity of the switching mechanism. By connecting a moisture detection portion with an input jack 701, the cathode of the moisture detection portion is connected with the base of a first-stage NPN transistor (Q1) 702 and the anode with the emitter of the first-stage NPN transmitter (Q1) 702. When the threshold voltage of first-stage transistor 702 is met or exceeded by current from the cathode and anode of the moisture detection portion, first-stage transistor 702 allows current from a first source 705 to flow to a second-stage transistor (Q2) 704. Once the threshold voltage of second-stage transistor 704 is met or exceeded by current from first power source 705, second-stage transistor 704 allows current to flow from a second power source 706 to drive a load 707, such as one or more circuits of a transmitter or notification device. The first and second power sources may comprise the same power source.

In the embodiment shown in FIG. 7, a user may adjust a potentiometer (VR1) 703 that varies the resistance along the path from first-stage transistor 702 to second-stage transistor 704. Potentiometer 703 limits the current that flows from first-stage transistor 702 to second-stage transistor 704. As resistance is decreased, more current from first power source 705 flows toward second-stage transistor 704. As resistance is increased, less current flows from first power source 705 to second-stage transistor. Power from second power source 706 then drives load 707. In this way, users may adjust the amount of current that must flow from first-stage transistor 702 to second-stage transistor 704, before second-stage transistor 704 is turned on and drives load 707. Varying the sensitivity of the switching mechanism allows garment wearers and care providers to avoid wasting garments by changing them before it is necessary to do so.

FIG. 8 is a circuit diagram illustrating a preferred embodiment of a switching mechanism having variable sensitivity, in accordance with the current invention. This embodiment utilizes two cascaded NPN transistors, a capacitor, and a potentiometer for allowing a user to select the sensitivity of the switching mechanism. By connecting a moisture detection portion with input terminals 800 and 801 the cathode of the moisture detection portion is connected with the base of a first-stage NPN transistor (Q1) 802 and the anode with the emitter of the first-stage NPN transistor (Q1) 802.

In the path between the cathode and the first-stage transistor 802 is a circuit containing potentiometer 803 (VR1), resistor 808 and capacitor 809. Transistor 802 will not turn on until capacitor 809 is fully charged. Potentiometer 803 and resistor 808 act to bleed the capacitor 809 (that is, shunts current to ground) if low-level currents are present such that capacitor 809 will not charge, allowing transistor 802 to turn on. Resistor 808 provides a minimum resistance so that the cathode is never grounded out. As the resistance at potentiometer 803 is decreased, low-level to even high currents can be bled off or diverted to ground so that capacitor 809 is never charged and transistor 802 will never turn on. If the resistance at potentiometer 803 is sufficiently increased, even low-level currents will not bleed off quickly enough and they can then charge the capacitor 809 and allow transistor 802 to turn on. In this way, a user may control whether momentary currents from the moisture detection portion will turn on the first-stage transistor 802.

When the threshold voltage of first-stage transistor 802 is met or exceeded by current from the cathode and anode of a moisture detection portion, first-stage transistor 802 allows current from a first source 805 to flow to a second-stage transistor (Q2) 804. Once the threshold voltage of second-stage transistor 804 is met or exceeded by current from first power source 805, second-stage transistor 804 allows current to flow from a second power source 806 to drive a load 807, such as one or more circuits of a transmitter or base unit. The first and second power sources may comprise the same power source.

Those skilled in the art will appreciate that the switching mechanism of the current invention may be arranged in various combinations of NPN and PNP transistors with input jacks and input terminals, without departing from the scope of the current invention. Additionally, as described herein, components other than transistors and potentiometers, which provide like functionality, may be used in place of the first-stage transistor, second-stage transistor, or potentiometer, or any combination thereof.

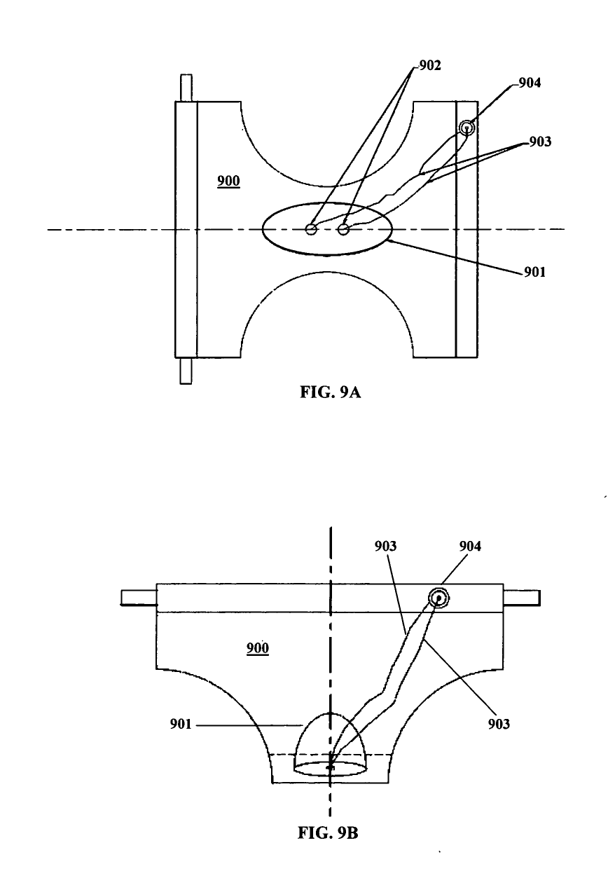

FIGS. 9A and 9B illustrate one embodiment of the system described herein, as its components are integrated with a garment. These figures illustrate a diaper 900, but those skilled in the art will recognize that the system may be integrated with other garments and undergarments in like fashion, without departing from the scope of the invention. In the embodiment shown in FIGS. 9A and 9B, at least one moisture detection portion 901 is integrated with the garment 900. Each moisture detection portion 901 contains two electrodes 902, as described herein, one being a cathode and one an anode. The electrodes 902 connect with switching mechanisms located in one or more snap units 904, via wires 903. Wires 903 may connect with snap 904 via input jack or terminal connections. Wires 903 are preferably placed underneath or within the material of garment 900, such that they do not directly touch the wearer.

In the embodiment shown in FIGS. 9A and 9B, moisture detection portion 901 is shown with a housing or panel that surrounds the electrodes, and which is sufficiently flexible that it follows the contours of the garment 900, as it is folded and worn. Moisture detection portion 901 is positioned on the garment at any place where moisture may collect or contact the garment and may be positioned differently within female and male garments. The panel or housing allows moisture detection portion 901 to be produced and sewn into garment 900 as a single unit. Alternatively, the garment 900 may be formed, such that moisture detection portion 901 and garment 900 are of unitary construction. Alternatively, moisture detection portion 901 may be removably attached with the inside of the garment, via hook-and-loop fasteners, for example, such that it may be positioned optimally for leak detection.

Though only one moisture detection portion 901 is shown in FIGS. 9A and 9B, multiple moisture detection portions may be integrated with garment 900. For example, one may be positioned at the rear of the worn garment 900 and one at the front or bottom of the worn garment 900. Each moisture detection portion 900 may be covered by a portion of porous, absorbent or other material, such that the electrodes do not directly touch the garment wearer, yet the electrodes still detect the presence of moisture.

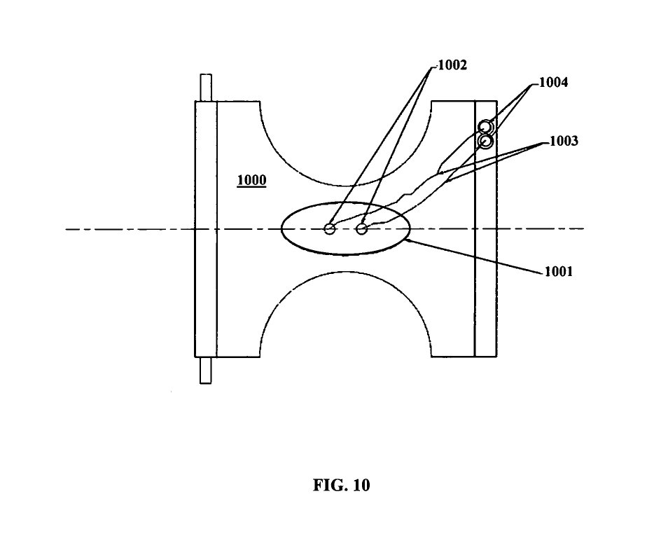

FIG. 10 illustrates a second embodiment of the system described herein, as its components are integrated with a garment. These figures illustrate a diaper 1000, but those skilled in the art will recognize that the system may be integrated with other garments and undergarments in like fashion, without departing from the scope of the invention. In the embodiment shown in FIG. 10, at least one moisture detection portion 1001 is integrated with the garment 1000. Each moisture detection portion 1001 contains two electrodes 1002, as described herein, one being a cathode and one an anode. The electrodes 1002 connect with switching mechanisms located in one or more snap units 1004, via wires 1003. In this particular embodiment, wires 1003 each connect with a different snap 1004, via input jack or terminal connections. Wires 1003 are preferably placed underneath or within the material of garment 1000, such that they do not directly touch the wearer.

In the embodiment shown in FIG. 10, moisture detection portion 1001 is shown with a housing or panel that surrounds the electrodes, and which is sufficiently flexible that it follows the contours of the garment 1000, as it is folded and worn. Moisture detection portion 1001 is positioned on the garment at any place where moisture may collect or contact the garment and may be positioned differently within female and male garments. The panel or housing allows moisture detection portion 1001 to be produced and sewn into garment 1000 as a single unit. Alternatively, the garment 1000 may be formed, such that moisture detection portion 1001 and garment 1000 are of unitary construction. Alternatively, moisture detection portion 1001 may be removably attached with the inside of the garment, via hook-and-loop fasteners, for example, such that it may be positioned optimally for leak detection.

Though only one moisture detection portion 1001 is shown in FIG. 10, multiple moisture detection portions may be integrated with garment 1000. For example, one may be positioned at the rear of the worn garment 1000 and one at the front or bottom of the worn garment 1000. Each moisture detection portion 1000 may be covered by a portion of porous, absorbent or other material, such that the electrodes do not directly touch the garment wearer, yet the electrodes still detect the presence of moisture.

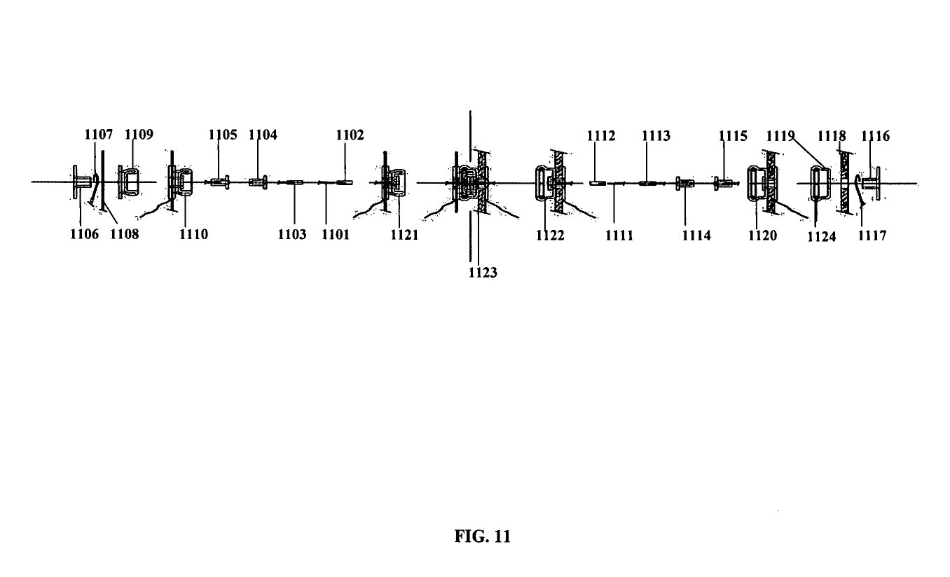

FIG. 11 illustrates a preferred manner of connecting wires extending from the electrodes of a moisture detection portion, as described herein, with a single snap unit, thereby forming a dual electrode device. A wire 1101 extending from one electrode of a moisture detection portion connects with an electrode 1102, as shown at 1103. The combination of wire 1101 and electrode 1102 is inserted into an isolator 1104, as shown in 1105. A second wire 1107 connects eyelet 1106 to one or more switching mechanisms or other circuitry. Eyelet 1106 extends through garment wall 1108 into stud 1109, as shown at 1110. The combination of wire 1101, electrode 1102, and isolator 1104, as shown in 1105, is inserted through stud 1109, into eyelet 1106, as shown at 1121, such that electrode 1102 is electrically connected with both wire 1101 and second wire 1107.

The connection of a wire 1111 extending from the other electrode of the moisture detection portion, with the snap unit, mirrors that described above. Wire 1111 connects to electrode 1112, as shown at 1113. The combination of wire 1111 and electrode 1112 is inserted into an isolator 1114, as shown at 1115. A fourth wire 1117 connects button 1116 to one or more switching mechanisms or other circuitry. Button 1116 extends from within the housing 1118 containing the switching mechanism(s) into a socket 1119, as shown at 1120. Socket 1119 contains a spring 1124. The combination of wire 1111, electrode 1112, and isolator 1114, as shown in 1115, is inserted through socket 1119, into button 1116, as shown at 1122, such that electrode 1112 is electrically connected with both wire 1111 and fourth wire 1117. The snap unit is then assembled, by inserting the stud of the male assembly 1121 into the socket of the female assembly 1122, as shown at 1123. Spring 1124 forces electrodes 1102 and 1112 together, when the snap unit is assembled.

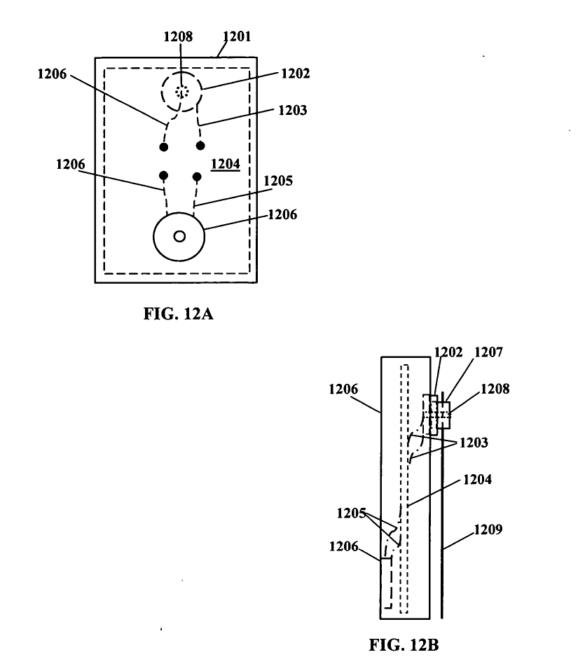

FIGS. 12A and 12B illustrate one embodiment of a snap unit attached with a housing containing a switching mechanism and notification device. The male assembly 1207 of a snap unit extends through garment wall 1209. The female assembly 1202 of a snap unit extends from within housing 1201. The male assembly 1207 is removably attached with the female assembly 1202, as described with reference to FIG. 11. Wires 1203 connect with the snap unit via the female assembly 1202 and via the electrode 1208 that runs through the female assembly 1202, as described with reference to FIG. 11. Wires 1203 connect with one or more switching mechanisms 1204 or other circuitry. Wires 1205 connect the one or more switching mechanisms 1204 or other circuitry with a notification device 1206. Notification device 1206 may be an alarm with volume control, a piezoelectric buzzer with volume control, an audio speaker with volume control, a light or LED, a vibrating component, or any combination of these. The switching mechanism(s) or other circuitry 1204 may also be integrated with notification device 1206, as described previously. Additionally, a transmitter may be used in place of notification device 1206, or a transmitter and local notification device may be used, as described previously.

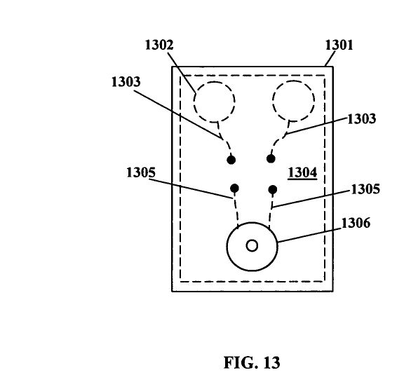

FIG. 13 illustrates a second embodiment of a snap unit attached with a housing containing a switching mechanism and notification device. This particular embodiment uses two snap units. In this embodiment, wires 1303 are each connected with a separate female snap assembly 1302. Wires 1303 connect with one or more switching mechanisms 1304 or other circuitry located with a housing 1301. Wires 1305 connect the one or more switching mechanisms 1304 or other circuitry with a notification device 1306. Notification device 1306 may be an alarm with volume control, a piezoelectric buzzer with volume control, an audio speaker with volume control, a light or LED, a vibrating component, or any combination of these. The switching mechanism(s) or other circuitry 1304 may also be integrated with notification device 1306, as described previously. Additionally, a transmitter may be used in place of notification device 1306, or a transmitter and local notification device may be used, as described previously.

The embodiments and figures described above are for example purposes only and are not intended to limit the scope of the invention. Those skilled in the art will recognize that many variations upon the current invention may be made without departing from its scope. For instance, multiple detectors may be placed in a single garment, in series or in parallel, and may be used in conjunction with one or more transmitters or notification devices.

What is claimed is:

1. A system for detecting moisture in a garment, comprising:
at least one moisture detection portion integrated with the garment, each moisture detection portion comprising a cathode and an anode;
at least one switching mechanism for receiving a positive voltage from the cathode and the anode of a moisture detection portion;
each switching mechanism comprising at least one switching component and at least one power source; and
each switching mechanism supplying current from at least one of its power sources to at least one notification device, when at least one of the switching components of the switching mechanism is activated.

2. The system of claim 1, wherein each moisture detection portion further comprises a housing surrounding the cathode and the anode.

3. The system of claim 1, wherein each switching component comprises a component selected from a group consisting of a switching transistor, a voltage comparator, an operational amplifier, a thyristor, and a field-effect transistor.

4. The system of claim 1, wherein each switching component is activated, when the switching component receives a voltage that exceeds a threshold voltage of the switching component.

5. The system of claim 4, wherein the threshold voltage is zero volts.

6. The system of claim 4, wherein the threshold voltage is greater than zero volts.

7. The system of claim 1, wherein a sensitivity of each switching mechanism is adjustable.

8. The system of claim 1, wherein each notification device comprises at least one device selected from a group consisting of a light, a light-emitting diode, a vibrating portion, an alarm with volume control, a piezoelectric buzzer with volume control, and an audio speaker with volume control.

9. The system of claim 1, wherein
the anode and the cathode of each moisture detection portion are electrically connected with a snap unit comprising a dual electrode; and
the snap unit is electrically connected with the at least one switching mechanism.

10. The system of claim 1, wherein
the anode is electrically connected with a first snap unit;
the cathode is electrically connected with a second snap unit; and
the first and second snap units are electrically connected with the at least one switching mechanism.

11. A system for detecting moisture in a garment, comprising:
at least one moisture detection portion integrated with the garment, each moisture detection portion comprising a cathode and an anode;
at least one switching mechanism for receiving a positive voltage from the cathode and the anode of a moisture detection portion;
each switching mechanism comprising at least one switching component and at least one power source;
each switching mechanism supplying current from at least one of its power sources to at least one transmitter, when at least one of the switching components of the switching mechanism are activated; and
each transmitter communicating with at least one remote notification device.

12. The system of claim 11, wherein each moisture detection portion further comprises a housing surrounding the cathode and the anode.

13. The system of claim 11, wherein each switching component comprises a component selected from a group consisting of a switching transistor, a voltage comparator, an operational amplifier, a thyristor, and a field-effect transistor.

14. The system of claim 11, wherein each switching component is activated, when the switching component receives a voltage that exceeds a threshold voltage of the switching component.

15. The system of claim 14, wherein the threshold voltage is zero volts.

16. The system of claim 14, wherein the threshold voltage is greater than zero volts.

17. The system of claim 11, wherein a sensitivity of each switching mechanism is adjustable.

18. The system of claim 11, further comprising a local notification device.

19. The system of claim 11, wherein each remote notification device comprises at least one apparatus selected from a group consisting of a light, a light-emitting diode, a vibrating portion, an alarm with volume control, a piezoelectric buzzer with volume control, and an audio speaker with volume control.

20. The system of claim 18, wherein each local notification device comprises at least one apparatus selected from a group consisting of a light, a light-emitting diode, a vibrating portion, an alarm with volume control, a piezoelectric buzzer with volume control, and an audio speaker with volume control.

21. The system of claim 11, wherein each transmitter communicates with at least one notification device via at least one signal selected from a group consisting of radio waves, infrared radiation, rolling code signals, billion code signals, 9-pin DIP code signals, and 12-pin DIP code signals.

22. The system of claim 11, wherein
the anode and the cathode of each moisture detection portion are electrically connected with a snap unit comprising a dual electrode; and
the snap unit is electrically connected with the at least one switching mechanism.

23. The system of claim 11, wherein
the anode is electrically connected with a first snap unit;
the cathode is electrically connected with a second snap unit; and
the first and second snap units are electrically connected with the at least one switching mechanism.
